(19) United States
(12) Patent Application Publication
(10) Pub. No.: US 2024/0426864 A1
(43) Pub. Date: Dec. 26, 2024

(54) LIQUID-BASED CMOS MEMS MICRO THERMAL CONVECTIVE ACCELEROMETER

(71) Applicant: The Hong Kong University of Science and Technology, Hong Kong (CN)

(72) Inventors: Yi-Kuen LEE, Hong Kong (CN); Xiaoyi WANG, Hong Kong (CN); Huahuang LUO, Hong Kong (CN)

(21) Appl. No.: 18/262,738

(22) PCT Filed: Jan. 25, 2022
(86) PCT No.: PCT/CN2022/073851

§ 371 Date: Jul. 25, 2023

Related U.S. Application Data
(60) Provisional application No. 63/141,067, filed on Jan. 25, 2021.

(51) Int. Cl. G01P 15/00; G01K 7/22

(52) U.S. Cl. CPC G01P 15/00; G01K 7/22

(57) ABSTRACT

This invention refers to a liquid-based micro thermal convective accelerometer (MTCA) optimized using a compact model based on the Rayleigh number (Ra). The MTCA is fabricated using CMOS MEMS technology. To ensure water resistance, an isolation layer such as a waterproof cover, exemplified by the conformal Parylene C coating, is employed. The device's performance is assessed in terms of sensitivity, response time, and noise. Theoretical and experimental findings establish that fluids with higher Ra numbers yield improved MTCA performance. Ra-based model showed its advantage to make a more accurate prediction than the simple linear model to select suitable fluid to enhance the sensitivity and balance the linear range of the device. In some cases, the liquid of MTCA can be selected as alcohol, and an alcohol-based MTCA was achieved with a two-order-of magnitude increase in sensitivity and one-order-of-magnitude decrease in the limit of detection compared with the air-based MTCA.

### FIELD OF THE INVENTION

The present invention relates to micro thermal convective accelerometers (MTCA) in general and, more particularly, to micro thermal convective accelerometers that use liquids as the working fluid.

### BACKGROUND

Accelerometers are used in a variety of devices and systems to measure acceleration including gravity, shock, rotation, vibration, etc. In accelerometers, a proof mass is used in conjunction with a spring. During an acceleration event, the measurement of the spring's compression during pushing of the proof mass can be related to the acceleration experienced by the proof mass.

Thermal accelerometers are devices that measure acceleration using the principle of thermal convection. In MEMS-based thermal accelerometers, a small heater is used to heat the fluid (gas or liquid), while a pair of symmetrically-disposed sensors temperature detectors measure the temperature difference induced by heat flow from the heater and the input acceleration. The Rayleigh number is a dimensionless number in fluid mechanics and heat transfer, which is the ratio of nature convection and thermal diffusion and can be reorganized as the dimensionless input acceleration for a thermal accelerometer. Through elimination of the conventional proof mass, thermal accelerometers can be made more resistant to shock and vibration. Thermal accelerometers also demonstrate other advantages such as resistance to stiction and hysteresis. Thermal accelerometers are often termed “micro thermal convection accelerometer” (MTCA) due to their small size and the use of thermal convection of fluids in the device operation.

However, thermal accelerometers may lack the acceleration sensitivity and frequency response of conventional accelerometers, limiting their application in some systems requiring high sensitivity. Thus, there is a need in the art for improved thermal accelerometers with enhanced sensitivity and larger frequency response. This invention addresses this need.

### SUMMARY OF THE INVENTION

The present invention provides a MEMS thermal accelerometer based on a standard CMOS process on a silicon wafer. By using CMOS MEMS technology, the overall accelerometer can be made smaller as well as being able to be integrated with CMOS devices that is used in connection with the accelerometer. The accelerometer includes a cavity having a waterproof coating formed thereon. A resistive microheater is suspended over the cavity, the resistive microheater including a waterproof coating formed thereon. At least two temperature detectors are suspended over the cavity at a position upstream of the resistive microheater. The at least two temperature detectors include a waterproof coating formed thereon.

At least two temperature detectors are suspended over the cavity at a position downstream of the resistive microheater. The at least two temperature detectors include a waterproof coating formed thereon. A waterproof cover is positioned over the cavity, the resistive microheater, the at least two upstream temperature detectors, and the at least two downstream temperature detectors and is configured to enclose a convection liquid therein.

### BRIEF DESCRIPTION OF THE DRAWINGS

FIG. 1 is a top view of an accelerometer according to an embodiment;

FIG. 2 is a side view of the accelerometer of FIG. 1;

FIG. 3A shows a process used to create the accelerometer of FIG. 1;

FIG. 3B shows a related art accelerometer with a single temperature detector;

FIG. 3C is a perspective view of the accelerometer of FIG. 1;

FIG. 4 is a schematic depiction of the operation of the accelerometer of FIG. 1;

FIG. 5 is a plot of output according to Rayleigh number;

FIG. 6 is a predicted output of nine types of fluids;

FIG. 7 is a theoretical analysis of output for three types of fluids;

FIG. 8. is a plot of accelerometer output with different temperature detector locations;

FIG. 9 is a schematic of CV heater power and a readout circuit;

FIG. 10 is a comparison between single detector and dual detector accelerometers;

FIG. 11 is a plot of the accelerated life testing for a waterproof coating on the accelerometer;

FIG. 12A-12C show a burn test (12A) and the results of safe operation temperature determination (12B) and heater temperature with coating (12C).

FIG. 13 is a comparison of three types of working fluids;

FIG. 14 is an acceleration test for different working fluids;

FIG. 15 shows the response time characterization for three working fluids;

FIG. 16 shows the noise analysis for three working fluids;

### DETAILED DESCRIPTION

Conventional thermal accelerometers use air as the working fluid. However, as discussed above, the conventional air-based thermal accelerometers lack the sensitivity needed for many commercial applications. Accordingly, the present invention determined that the use of liquids as the working fluid, in connection with the accelerometer described below, provides thermal accelerometers with a greater sensitivity. This was demonstrated and explained by theoretical modelling of thermal accelerometers.

### A. Theoretical Modeling of MTCA (Microthermal Convection Accelerometer)

A new one-dimensional (1D) model was proposed using the key parameters as shown in FIG. 5 to predict the characteristics of a MEMS-based thermal convective accelerometer by considering the circular flow field and linear temperature distribution in an enclosing chamber. The model is depicted as a 2nd order ordinary differential equation (ODE) as follows:

$$Equation ( 1 )$$

$$( H + 2 \frac{{k}_{s}}{{k}_{f}} t + h ) \frac{{d}^{2} T ( x )}{{dx}^{2}} - 2 ( \frac{1}{H} + \frac{1}{h} ) T ( x ) - \frac{1}{320} \frac{ρ {C}_{p} β {a}_{i} \frac{( {T}_{h} - {T}_{a} )}{2 {k}_{f}} ( {H}^{3} + {h}^{3} )}{v} \frac{dT ( x )}{dx} = 0$$

where aᵢ is the input acceleration; Tₐ and Tₕ are the boundary temperatures of the enclosed chamber and heater, respectively; β and v are the thermal expansion coefficient and the kinetic viscosity of the working fluid, respectively. k_{f} and kₛ are the thermal conductivity of working fluid and thin film, respectively; H and h are the top and bottom boundaries of temperature and circular flow; t is the film thickness; Cₚ is the thermal capacity of the working fluid. For further analysis, the normalized output ΔT*(ΔT*=ΔT/ΔTₕ) is calculated, which is a function of dimensionless input parameter (related to the normalized acceleration and thermal properties) ϕ=Rₐ, shown in equation (2):

$${R}_{a} = \frac{{a}_{i}}{{vk}_{f} / ( ρ {C}_{p} β \frac{( {T}_{h} - {T}_{a} )}{2} {δ}^{3} )} ,$$

$$δ = H or h$$

The Rayleigh number is a dimensionless number to describe the ratio of free convection and thermal diffusion. The larger this number, the stronger the free convection and higher sensitivity with the same input acceleration shown in equation (3):

$$Δ {T}^{*} = Δ T / Δ {T}_{h} = f ( ϕ ) = f ( Ra ) = f ( Pr , Gr )$$

Based on the previous conclusion that when the Rayleigh number exceeds the critical value (R_{ac}=3000), the behavior of the micro thermal convective accelerometer would tend to be nonlinear. In that way, using the linear model to predict the performance of the micro thermal convective accelerometer would not be precise. From equations (2) and (3), it can be seen that not only the input acceleration aᵢ, but also the thermal properties of fluid would influence the magnitude of the Rayleigh number, which is summarized in Table I by comparing with nine types of fluids.

TABLE I
SUMMARY OF THE THERMAL PROPERTIES OF NINE
TYPES OF FLUIDS [25] AND THE CORRESPONDING
RAYLEIGH NUMBER (ΔTₕ = 300 K).

| | | β | ν | | | |
|---|---|---|---|---|---|---|
| | ρ | (1/K) | (m²/s) | Cp | k | Ra |
| Item | (Kg/m³) | *10⁻³ | * 10⁻⁵ | (J/Kg · K) | (W/m · K) | (@ 1 g) |
| He | 0.164 | 1.5 | 1.98 | 5193 | 0.1553 | 0.95 |
| Ne | 0.825 | 1.5 | 3.11 | 1030.4 | 0.0481 | 9.79 |
| N₂ | 1.146 | 1.5 | 1.78 | 1041.3 | 0.0257 | 62.4 |
| Ar | 1.635 | 1.5 | 2.26 | 521.6 | 0.0176 | 73.4 |
| CO₂ | 1.809 | 1.5 | 1.49 | 850.7 | 0.0166 | 235 |
| SF₆ | 6.042 | 1.5 | 1.56 | 668.3 | 0.0149 | 2193 |
| C₂F₆ | 5.704 | 1.5 | 1.41 | 775.5 | 0.0148 | 2520 |
| C₃F₈ | 7.857 | 1.5 | 1.25 | 796.6 | 0.0125 | 6588 |
| C₄F₈ | 8.434 | 1.5 | 1.15 | 791.1 | 0.0122 | 8382 |

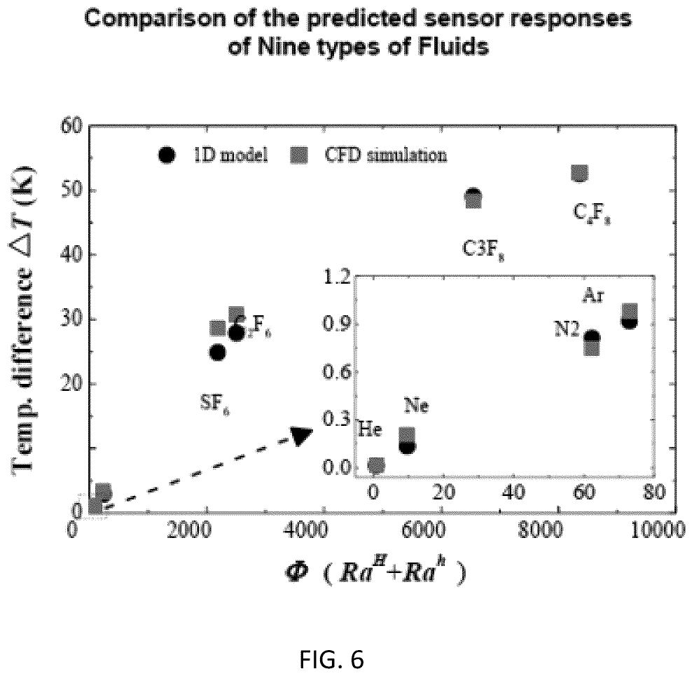

Based on the analysis of compact model, the performance of MTCA could be predicted, which is shown in FIG. 6. FIG. 6 shows that the Rayleigh number can be a reliable predictor about which type of fluid to select to provide a better performance. However, due to the saturation effect, the relationship between output and Rayleigh number is not linear after the critical value R_{ac}, which means that it is not precise to use the linear model to predict the performance of whole measurement range for those fluids with higher Rayleigh number.

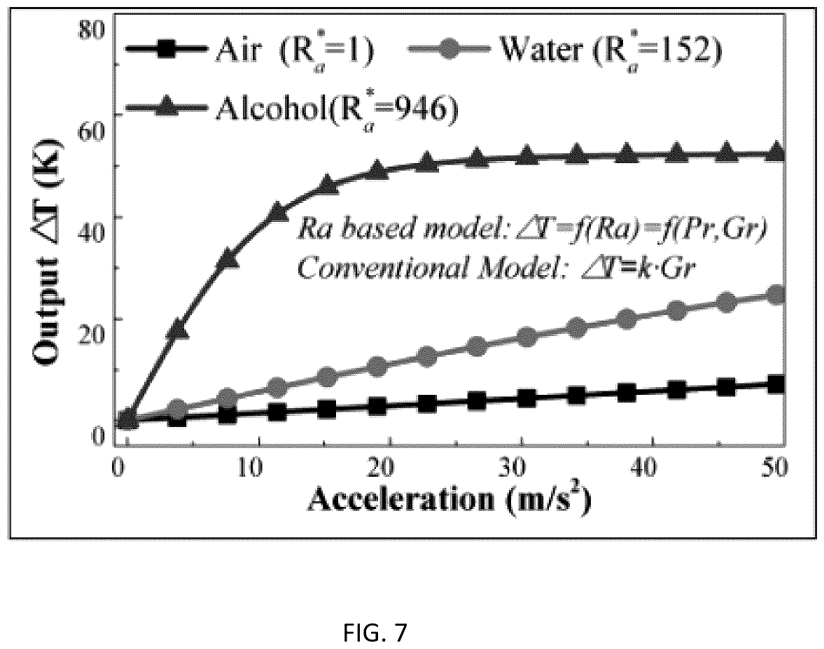

Based on this determination, using liquids as the working fluid provides a higher Rayleigh number, which means that the sensitivity of the accelerometer may be significantly improved. To improve the performance of accelerometer, the compact model is used to analyze the performance of three types of fluids: gas (air) and two types of liquids (water and alcohol). The normalized Rayleigh number (Ra*) of these three types of fluids is listed in Table II. The predicted performance based on these three types of fluids is listed in FIG. 7. FIG. 7 shows that water and alcohol provide higher outputs, but due to the nonlinear behavior, the output of alcohol tends to be saturated when exceeding an acceleration of 25 m/s².

TABLE II
NORMALIZED RAYLEIGH NUMBER FOR
AIR, WATER, AND ALCOHOL.

| Item | Air | Water | Alcohol |
|---|---|---|---|
| Ra* | 1 | 152 | 946 |

Rₐ* = Rₐ/R_{a, air} is the normalized Rayleigh number under an overheated temperature of 80 K.

### B. Thermal Accelerometer Design

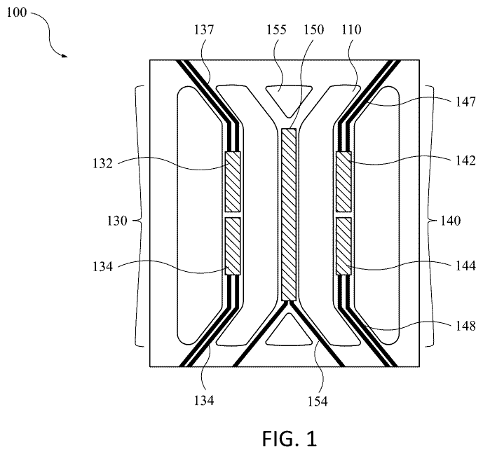

Based on the above analysis, the present invention provides a thermal accelerometer using a liquid as the heated fluid whose temperature profile is related to acceleration. In order to use a liquid as opposed to gaseous fluids, a new, waterproof accelerometer design is needed to prevent short-circuiting among the device components and to prevent escape of the liquid. FIG. 1 is a top view of a CMOS-based MEMS thermal accelerometer 100 according to an embodiment. The term “CMOS-based MEMS” as used herein, means the construction of a MEMS (micro-electromechanical system) device in a fabrication platform provided by CMOS (complementary metal oxide semiconductor) foundries (such as TSMC), examples of which are set forth below. By using a CMOS MEMS technology, the overall accelerometer can be made smaller as well as being able to be integrated with CMOS devices that can be used in connection with the accelerometer.

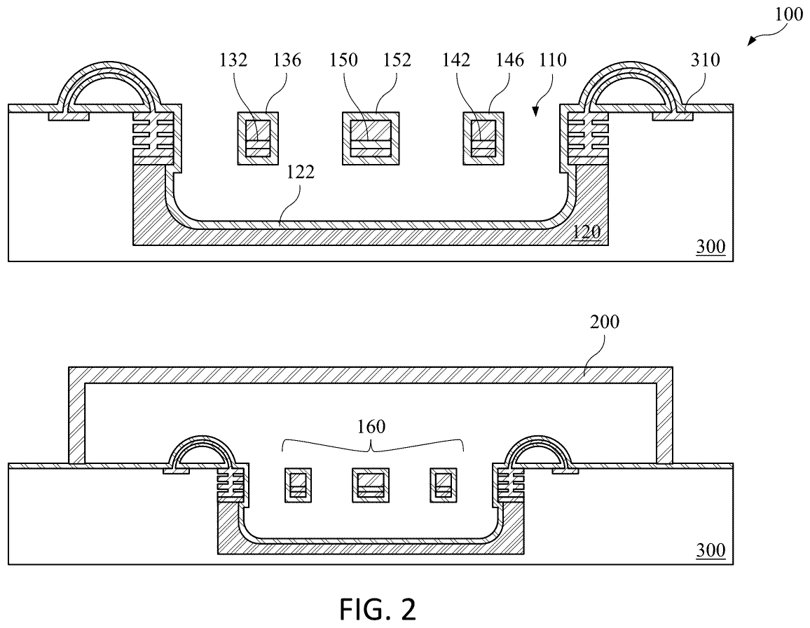

As seen in FIG. 1 and the cross-sectional view of FIG. 2, the accelerometer 100 includes various elements suspended over a cavity 110. In one aspect, the cavity may be micromachined, typically through etching, from a layer of silicon or polysilicon 120. The accelerometer cavity 110 has a waterproof coating 122 formed thereon. The waterproof coating 122 may be selected from a polymer such as a para-xylylene polymer or chlorinated poly (para-xylylene) polymer (e.g., PARYLENE C®). Other waterproof polymers such as acrylics, silicones, urethanes may also be used. In particular, conformal coatings are preferred.

A resistive microheater 150 is suspended over the cavity. As will be discussed in the fabrication details below, a series of beams 160 are formed from a layer of silicon oxide that extends over the cavity. Typically, these beams are micromachined from the same CMOS blank used to form the cavity. The various accelerometer elements are formed as layers on these beams. The resistive microheater can be a polysilicon microheater or may be a resistive thin film metal microheater. The resistive microheater includes a waterproof coating 152 formed thereon. Waterproof coating 152 may be the same as or different to the coating used for the accelerometer cavity.

At least two upstream temperature detectors 130 are suspended over the cavity 110 at a position upstream of the resistive microheater 150. As best seen in FIG. 1, each temperature detector 132, 134 is positioned equidistant from the resistive microheater 150. The temperature detectors 132, 134 include a waterproof coating 136 formed thereon which may be made from the above-listed polymers. In the embodiments of the present invention, temperature detectors can be implemented using at least two types of measurement processes, namely, resistive and thermopile-based processes. That is to say, the temperature detector can be a thermoresistive temperature detector or a thermopile temperature detector.

At least two downstream temperature detectors 140 are suspended over the cavity 110 at a position downstream of the resistive microheater 150. As best seen in FIG. 1, each temperature detectors 142, 144 is positioned equidistant from the resistive microheater 150. The temperature detectors 142, 144 include a waterproof coating 146 formed thereon which may be made from the above-listed polymers. All of the temperature detectors may be thin film metal temperature detectors or polysilicon temperature detectors.

A waterproof cover 200 is positioned over the cavity 110, the resistive microheater 150, the at least two upstream temperature detectors 130, and the at least two downstream temperature detectors 140. The waterproof cover may be made from a waterproof polymer with sufficient rigidity to protect the accelerometer and is configured to enclose the selected convection liquid therein. Exemplary polymers include, but are not limited to, polycarbonate, polymethyl methacrylate, polystyrene, or polyvinyl chloride.

Each of the resistive microheater 150 and temperature detectors 130, 140 is connected to their own respective bonding pad. Bonding pads are provided on a substrate 300, and each of them is connected to the circuit on PCB through corresponding aluminum wire 137/138/147/148/154/155 which is also covered by a waterproof coating. Metal bonding wires 310 provide an interconnection between the bonding pad and one or more of the printed conductors.

Due to the use of CMOS foundry as the fabrication platform, an ambient temperature compensation circuit may be disposed on the substrate and integrated with the thermal accelerometer. In addition to, or in the alternative, a frequency response compensation circuit may be disposed on the substrate and integrated with the thermal accelerometer.

### C. Method of Fabricating the Accelerometer

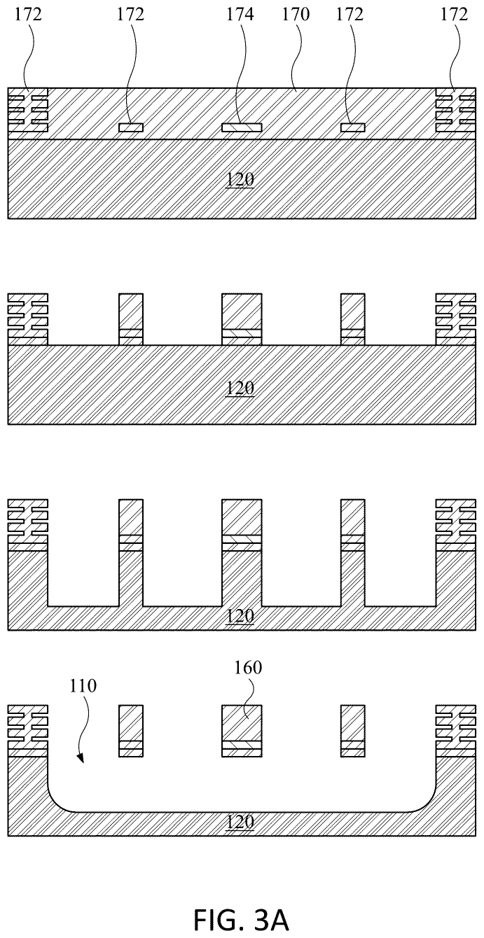

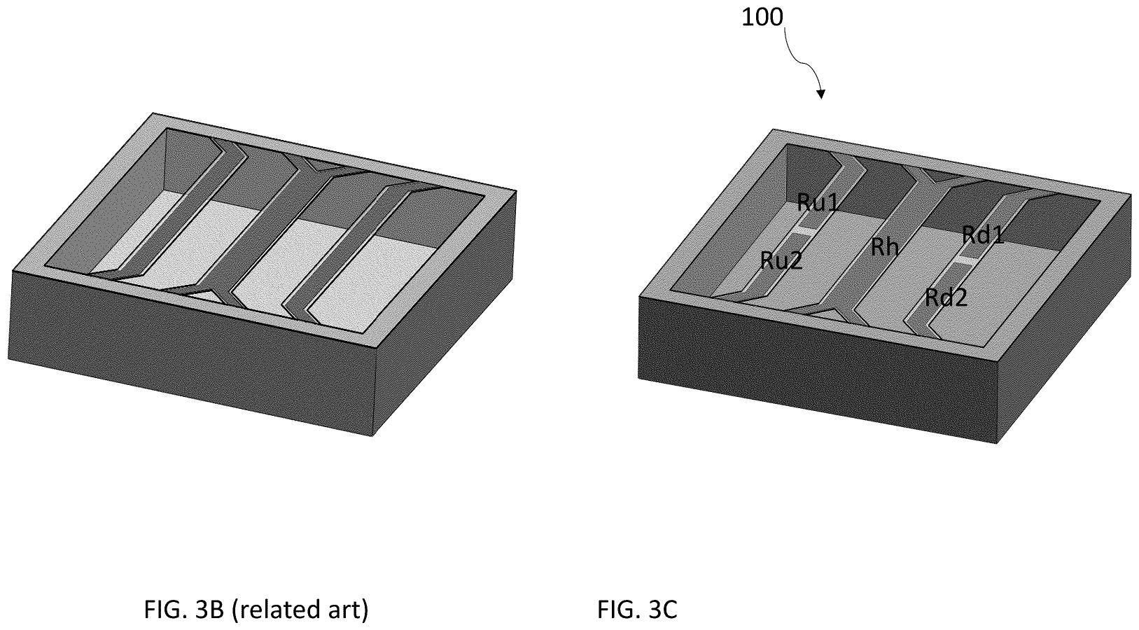

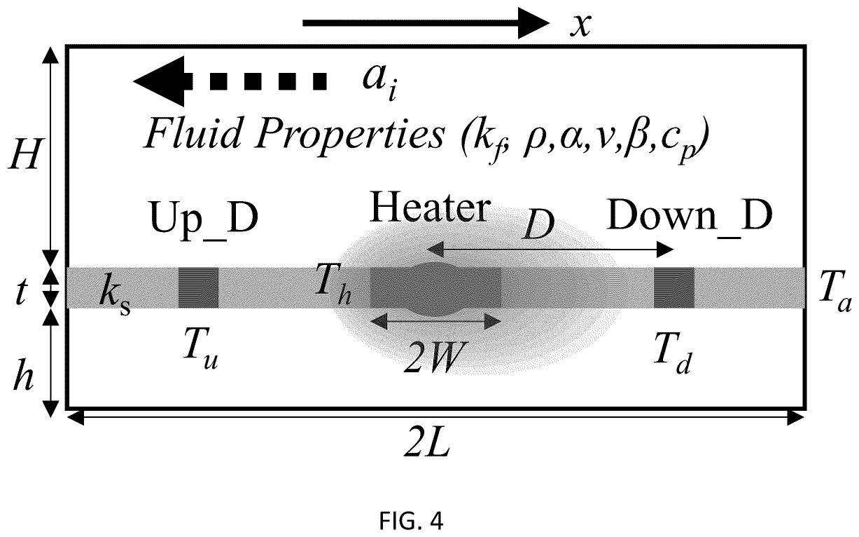

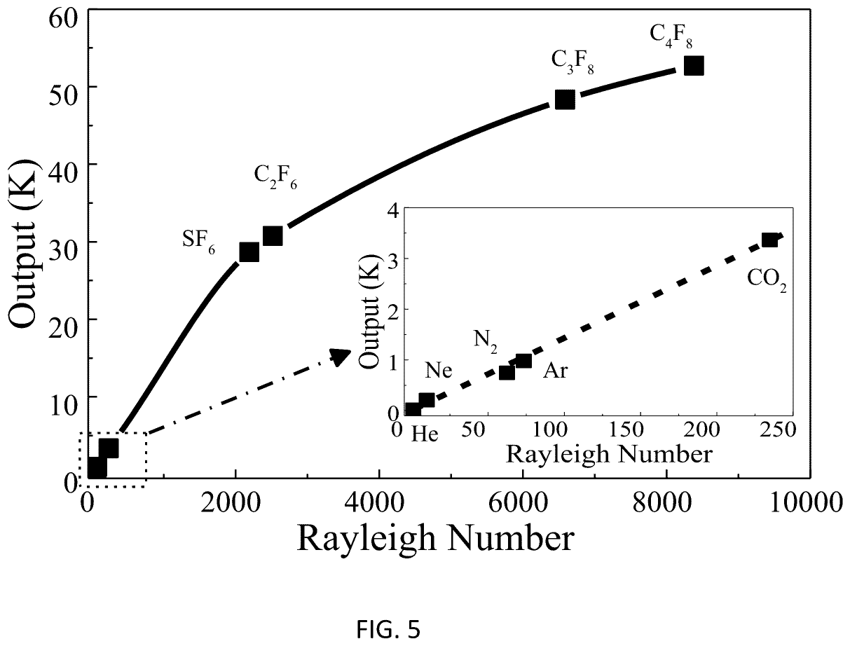

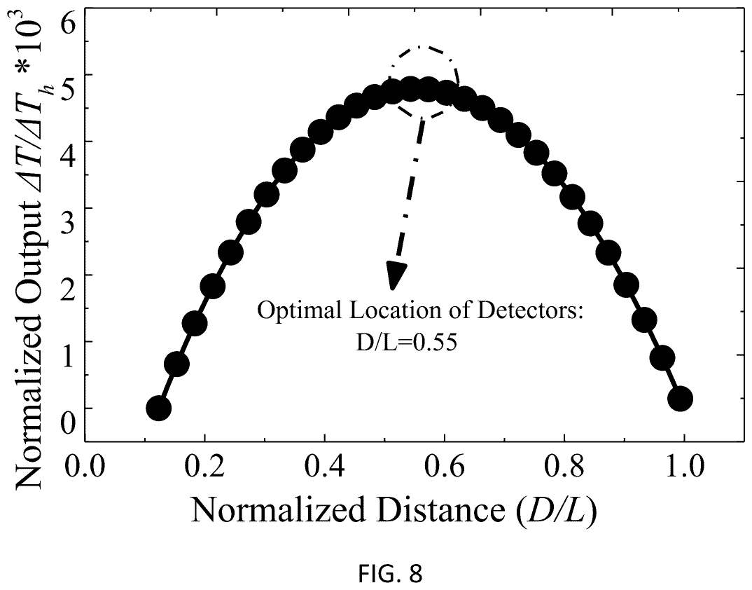

FIG. 3A depicts a sequence of processes used to fabricate the accelerometer of the present invention. For this liquid based MTCA, an AMS 0.35 μm 2P4M CMOS fabrication technology was used to create the device (or other CMOS foundry processes such as TSMC 0.18-micron 1P6M, UMC 0.18-micron 1P6M, etc.). The expression “2P4M” is a term used to denote 2 polysilicon (“P”) layers and 4 metal (“M”) layers. AMS refers to ams OSRAM AG, a semiconductor fabrication company. The size of the sensor is selected to be 600 μm*600 μm (width*length). As size is related to sensitivity, various overall device and cavity sizes can be selected based on the desired sensitivity of the accelerometer. As shown in FIG. 4, the key parameters of this MTCA are sensor size (L), heater width (W) and temperature detectors' location (D). The sensor size is limited by the design area and heater 150 width is fixed with the dimension of 75 μm. To optimize the location of detectors, the optimal location (D/L=0.55) of the temperature detector is predicted by the compact model shown in FIG. 8. The width of the temperature detector bridge is defined as 68 μm.

In this embodiment, aluminum (3.3e-3/K) with a higher temperature coefficient of resistance (TCR) is selected as the temperature sensing material since it is higher than that of polysilicon (0.9e-3/K). However, polysilicon may be used in other devices depending upon the accelerometer application.

FIG. 3B shows a conventional single temperature detector design. In contrast, the present invention provides a novel dual temperature detector configuration (FIG. 3C), as described above device is designed with DD (Dual Detectors) structure.

The accelerometer chip is fabricated by an AMS 0.35 μm CMOS MEMS process according to the processes shown in FIG. 3A. The initial CMOS layers are shown in 3A(i). They include a silicon substrate 120 with layers of aluminum 172 and polysilicon 174. To achieve the monolithic useful device, the following post-CMOS processes are conducted. In FIG. 3A(ii), the silicon oxide is etched to define the bridge/beams area with oxide etching. Silicon trenches are etched using DRIE etching in FIG. 3A(iii). The DRIE etching is followed by isotropic silicon etching (XeF₂) to release the structure from the silicon substrate and minimize the heat dissipation of the suspended thin-film structure as seen in FIG. 3A(iv). Then, the sensor chip is mounted into a machined cavity of a PCB board 300 (FIG. 2), followed by wire bonding and 2 μm conformal waterproof polymer (e.g., PARYLENE-C) coating to achieve the reliable water-proof property of the packaged MCTA (FIG. 2). Finally, the working fluid is sealed within a PMMA cover 200 (FIG. 2).

### D. Operation of the Accelerometer

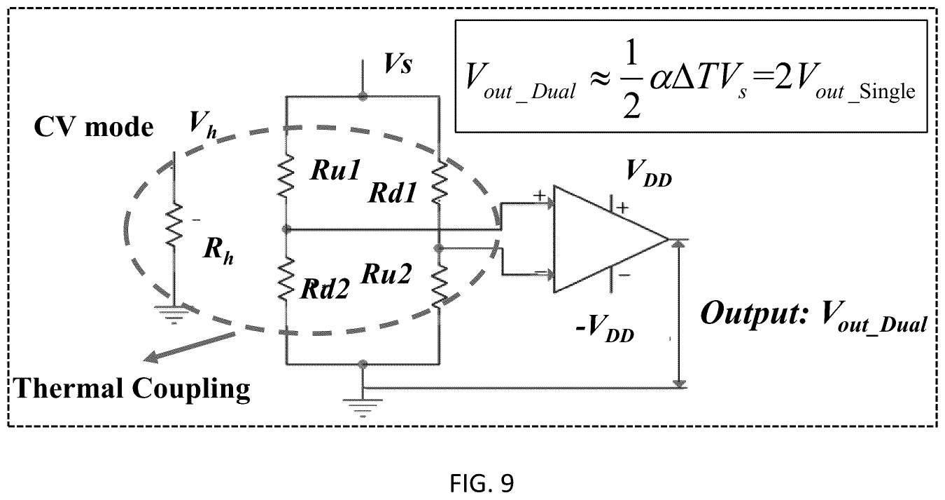

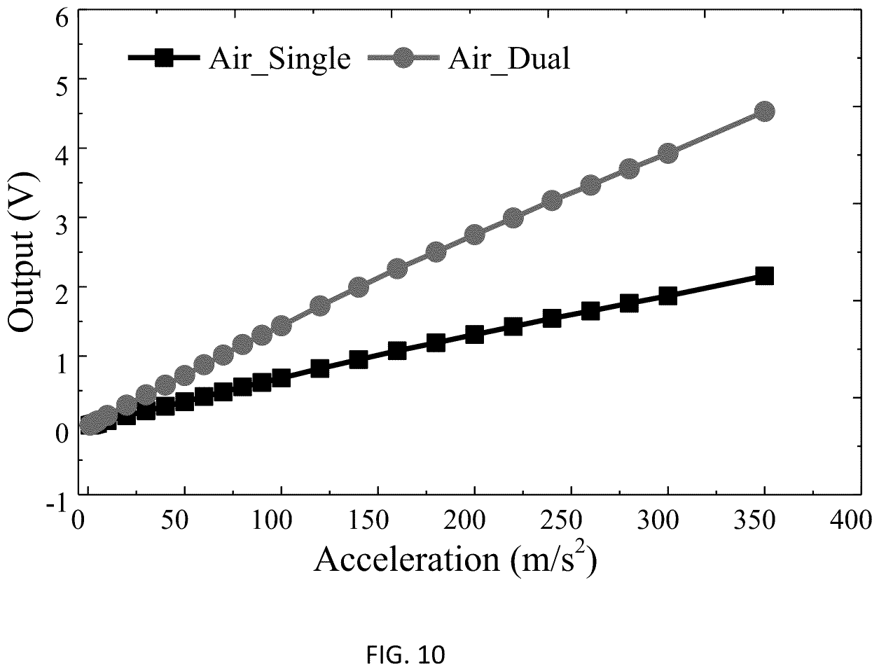

FIG. 4 schematically depicts the operation of the accelerometer of FIG. 1 and FIG. 2. As discussed above, the micro thermal accelerometer consists of three suspended beams 160 (FIG. 2), upon which are disposed the resistive microheater 150 located at the center, and two symmetrically-disposed temperature detectors 130 and 140 (up and down detectors) with respect to the central microheater. The microheater provides a working temperature of Tₕ, and two symmetric detectors can sense the local temperature of Tᵤ and Tₐ, respectively. In the absence of acceleration, the temperature profile T(x) across the thin film in the x-direction is symmetrically distributed. Under a condition of acceleration, due to the buoyant force, the input acceleration aᵢ will induce a circulation flow pattern inside the cavity, which will deform the original symmetrical temperature distribution in the chamber. Then, the differential temperature output (ΔT=T_{d}−Tᵤ) between two temperature detectors can be monitored. The temperature detectors are powered under constant-voltage (CV) mode and the detectors are assigned under the double output method illustrated in FIG. 9. Compared to the conventional single detector design's output V_{out_SD}, the output V_{out_DD} can be calculated with the following equation:

$${V}_{out \_ DD} \approx \frac{1}{2} αΔ {TV}_{s} = 2 {V}_{out \_ SD}$$

where α is the temperature coefficient of resistance; Vₛ is the supply voltage of the Wheatstone bridge.

### E. Waterproof Coating Long-Term Behavior

In one embodiment, Parylene-C is selected as the waterproof material. The Parylene-C coated accelerometer is expected to have long-term reliability. In order to predict the long-term behavior of the coated accelerometer, the micro thermal convective accelerometer can be subjected to the testing conditions (stress, strain, temperature, voltage, vibration rate, pressure etc.) in excess of its normal working conditions, which enables the determination of any faults and potential failure modes in a short period of time. For the waterproof coating, accelerated life testing based on thermal cycling was used. Thereby, the degradation rate for the coated Parylene-C material properties is exponentially increased with the temperature, which is generally described by an Arrhenius Equation. Therefore, the relation between the testing time tₜₑₛₜ and the estimated time of life t_{work} for the coated MTCA can be predicted as follows:

$${t}_{work} / {t}_{test} = exp [ \frac{{E}_{a}}{R} ( \frac{1}{{T}_{work}} - \frac{1}{{T}_{test}} ) ]$$

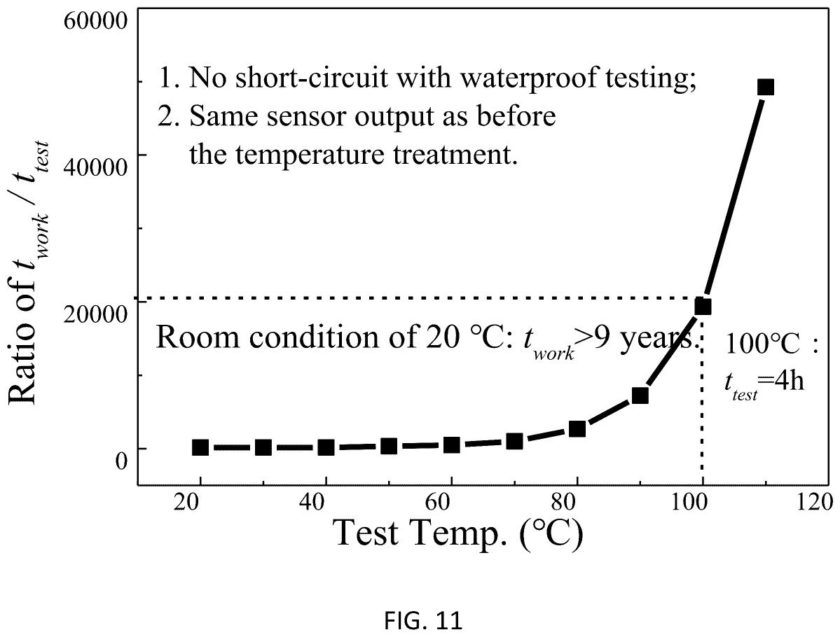

The coated thermal accelerometer was baked in an oven for 4 hours under 100° C. Afterward, the waterproof testing was performed and no short-circuit was observed from the resistance measurement. Further, the accelerometer still provides the same output as before the thermal treatment, and there were no significant changes or failures in the Parylene-C coated device. Therefore, as proved by the accelerated life testing in FIG. 11, it can be concluded that the conformal Parylene-C coating has more than 9 years of working lifetime under 20° C. normal working temperature.

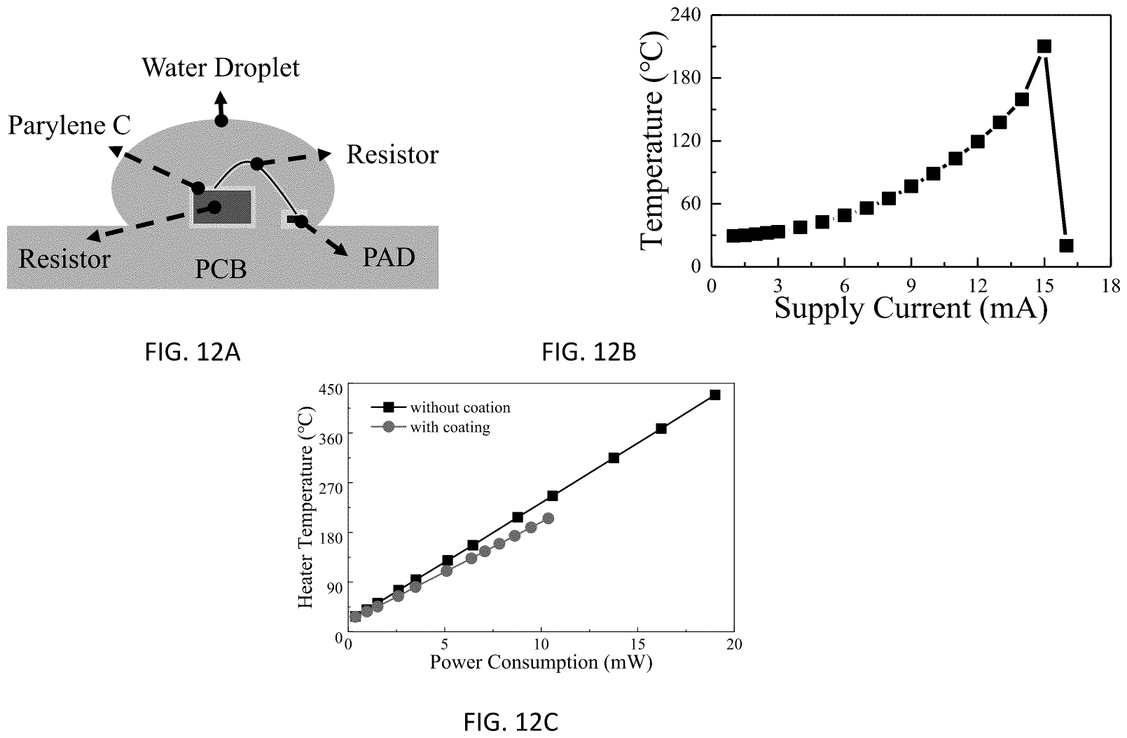

To determine the maximum operating temperature of the Parylene-C coating, a burn test (FIG. 12A) is performed; from this test, it is determined that the conformal coating can safely operate below 200° C. (FIG. 12B). This temperature is higher than the boiling temperature of either water or alcohol. Furthermore, the conformal Parylene-C coating film has different thermal properties than silicon oxide, which would result in the microheater temperature variation with the same power consumption. Then the heater temperature is characterized under different supply currents with and without Parylene-C coating (FIG. 12C), which shows that the Parylene-C coated sensor would have an average 15% temperature drop with the same power consumption.

### Example: Experimental Analysis of the Liquid-Based Accelerometer

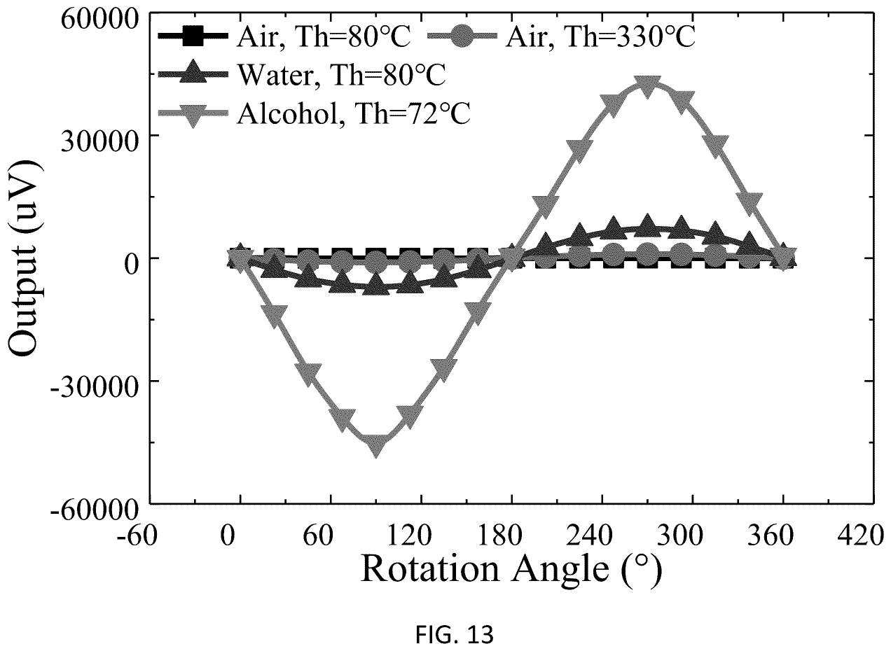

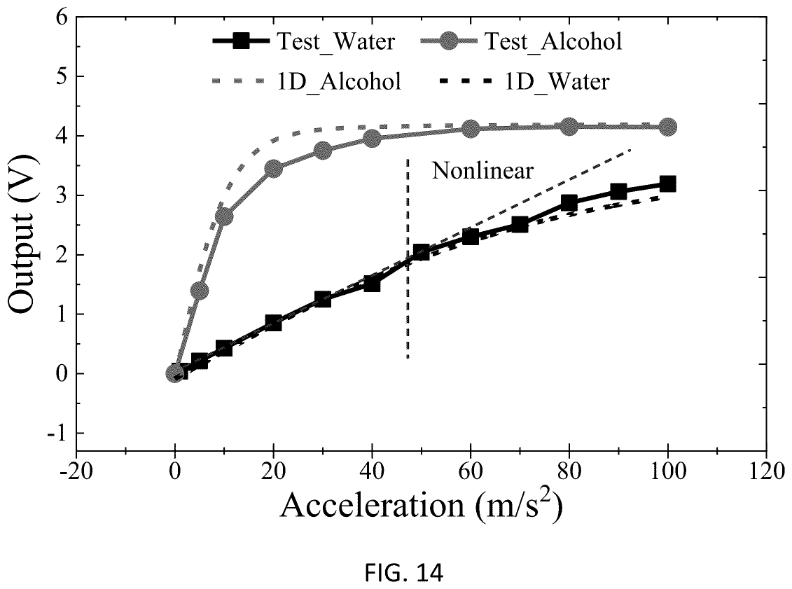

Three types of working fluids including air, water, and alcohol are tested. FIG. 13 demonstrates that alcohol, with its larger Rayleigh number, can significantly enhance the sensitivity (43.8 mV/g), followed by water (7.1 mV/g). Air-based accelerometers having a heater temperature (Tₕ) of 80° C. can only achieve a sensitivity of 28 μV/g, which can be improved to 1,002 μV/g by increasing Tₕ to 430° C. In addition, FIG. 14 demonstrates that the working fluid with a high Rₐ (e.g., alcohol) will contribute a distinct nonlinear behavior and small detection range, which is in good agreement with the compact model's predictions.

In addition to the sensitivity characterization, the response time is also tested. Fluids with a lighter density and larger thermal diffusivity are advantageous as a working medium for a higher frequency response. Based on the thermal properties listed in Table III, alcohol has an enhanced sensitivity, due to its lower diffusivity, it would obtain a lower frequency response.

TABLE III
THERMAL PROPERTIES COMPARISON
OF THREE TYPES OF FLUIDS

| Item | Air | Water | Alcohol |
|---|---|---|---|
| Density | 1.1774 | 997.4 | 785 |
| Diffusivity | 2.22e−5 | 1.45e−7 | 8.28e−8 |

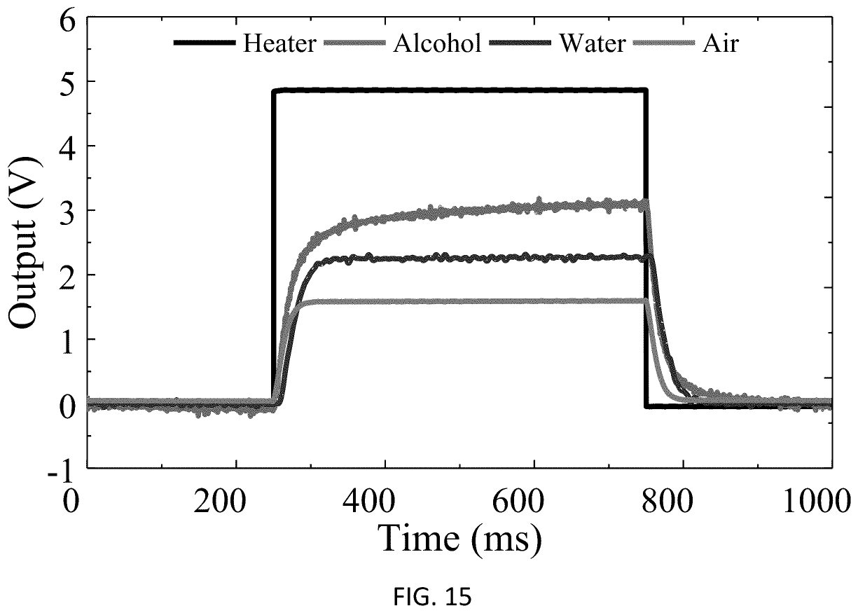

Characterizing the response time is quite important to evaluate the performance of liquid-based MTCAs. FIG. 15 shows that, among these three types of fluids, alcohol has the largest response time (235 ms), followed by water (111 ms) and air (16 ms), which means that a trade-off should be made to balance the sensitivity and bandwidth when selecting a suitable working.

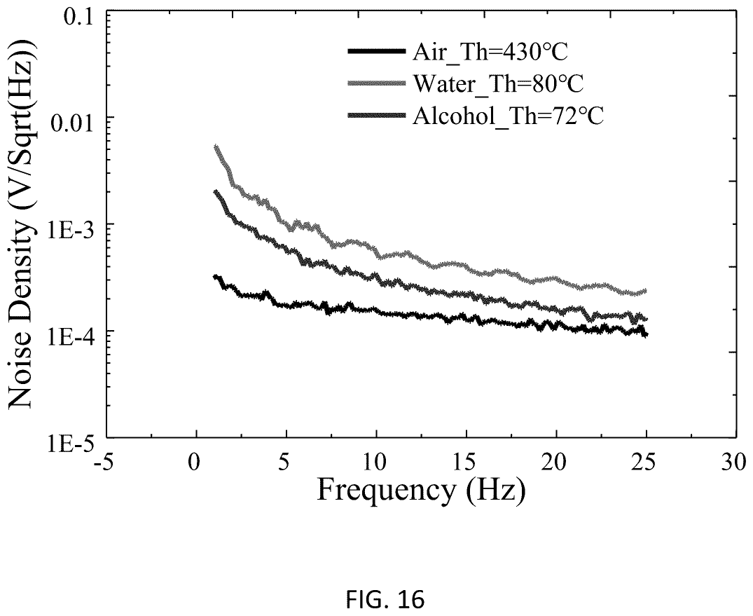

Additionally, noise is tested to check the minimum detection acceleration, which is shown in FIG. 16. Water has the largest noise spectrum density, followed by alcohol and air. After normalizing the noise value (Noise value/sensitivity), alcohol achieves the lowest minimum detection acceleration (MDA) of 61.9 μg, followed by air (757 μg) and water (916 μg). This comparison is summarized in Table IV, which demonstrates that the accelerometers of the present invention may improve the normalized sensitivity (3,344 μV/g/mW) by two orders of magnitude and improve the minimum detection acceleration (61.9 μg) by one order of magnitude as compared to air-based accelerometers.

TABLE IV
A COMPARISON AMONG MICROTHERMAL
CONVECTIVE ACCELEROMETERS

| | | S@1 g | P | S/P | | |
|---|---|---|---|---|---|---|
| Ref. | Fluids | (μV/g) | (mW) | (μV/g/mW) | FR | LOD |
| Park | Air | 70 | 10 | 7 | 50 Hz; | N/A |
| (MEMS) | SF₆ | 3,500 | 7.4 | 472 | 25 Hz | |
| Lin | Air | 75 | 7.1 | 10.6 | 25 ms; | N/A |
| (MEMS) | IPA | 13,200 | 13 | 1,009 | 500 ms | |
| Chaehoi | Air | 375 | 35 | 10.7 | 40 Hz | 30 mg |
| (CMOS) | | | | | | |
| Invention | Air | 1002 | 19 | 52.7 | 16 ms; | 757 μg; |
| (CMOS) | Water | 7,100 | 14 | 507 | 111 ms; | 916 μg; |
| | Alcohol | 43,800 | 13.1 | 3344 | 235 ms | 61.9 μg |

S = sensitivity, P = power consumption, FR = frequency response.

As used herein, for ease of description, space-related terms such as “under”, “below”, “lower part”, “above”, “upper portion”, “lower portion”, “left side”, “right side”, and the like may be used herein to describe a relationship between one element or feature and another element or feature as shown in the figures. In addition to orientation shown in the figures, space-related terms are intended to encompass different orientations of the device in use or operation. A device may be oriented in other ways (rotated 90 degrees or at other orientations), and the space-related descriptors used herein may also be used for explanation accordingly. It should be understood that when a component is “connected” or “coupled” to another component, the component may be directly connected to or coupled to another component, or an intermediate component may exist.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of +10%, +5%, +1%, or +0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

Several embodiments of the present disclosure and features of details are briefly described above. The embodiments described in the present disclosure may be easily used as a basis for designing or modifying other processes and structures for realizing the same or similar objectives and/or obtaining the same or similar advantages introduced in the embodiments of the present disclosure. Such equivalent construction does not depart from the spirit and scope of the present disclosure, and various variations, replacements, and modifications can be made without departing from the spirit and scope of the present disclosure.

1. A CMOS-based MEMS thermal accelerometer comprising:
a cavity having a waterproof coating formed thereon;
a resistive microheater suspended over the cavity, the resistive microheater including a waterproof coating formed thereon;
at least two upstream temperature detectors suspended over the cavity at a position upstream of the resistive microheater; the at least two upstream temperature detectors including a waterproof coating formed thereon;
at least two downstream temperature detectors suspended over the cavity at a position downstream of the resistive microheater; the at least two downstream temperature detectors including a waterproof coating formed thereon;
a waterproof cover positioned over the cavity, the resistive microheater, the at least two upstream temperature detectors, and the at least two downstream temperature detectors, the waterproof cover configured to enclose a convection liquid therein.

2. The CMOS-based MEMS thermal accelerometer of claim 1, wherein the cavity is a silicon cavity.

3. The CMOS-based MEMS thermal accelerometer of claim 1, wherein the two downstream temperature detectors are selected from aluminum or polysilicon temperature detectors.

4. The CMOS-based MEMS thermal accelerometer of claim 1, wherein the two upstream temperature detectors are selected from aluminum or polysilicon temperature detectors.

5. The CMOS-based MEMS thermal accelerometer of claim 1, wherein the resistive microheater is a polysilicon resistive microheater.

6. The CMOS-based MEMS thermal accelerometer of claim 1, wherein the cavity is coupled to a substrate.

7. The CMOS-based MEMS thermal accelerometer of claim 6, further comprising an ambient temperature compensation circuit disposed on the substrate and integrated with the thermal accelerometer.

8. The CMOS-based MEMS thermal accelerometer of claim 6, further comprising a frequency response compensation circuit disposed on the substrate and integrated with the thermal accelerometer.

9. The CMOS-based MEMS thermal accelerometer of claim 1, wherein the waterproof coating is a polymer coating.

10. The CMOS-based MEMS thermal accelerometer of claim 9, wherein the polymer coating is one or more selected from the group consisting of para-xylylene polymers, chlorinated poly (para-xylylene) polymers, urethane, acrylic, or silicone.

11. The CMOS-based MEMS thermal accelerometer of claim 1, wherein each of the at least two upstream temperature detectors is equidistant from the resistive microheater.

12. The CMOS-based MEMS thermal accelerometer of claim 1, wherein each of the at least two downstream temperature detectors is equidistant from the resistive microheater.

13. The CMOS-based MEMS thermal accelerometer of claim 1, wherein the convection liquid is water.

14. The CMOS-based MEMS thermal accelerometer of claim 1, wherein the convection liquid has a normalized Rayleigh number greater that of air.

15. The CMOS-based MEMS thermal accelerometer of claim 1, wherein a ratio of a position of the temperature detector to a width of the thermal accelerometer is determined by a curve of a compact model, wherein the compact model is determined by at least of one characteristics of the convective liquid, and the characteristics of the convective liquid comprise at least its normalized Rayleigh number.

16. The CMOS-based MEMS thermal accelerometer of claim 1, wherein a selection of the convective fluid is determined at least based on the normalized Rayleigh numbers of a plurality of candidate convective fluids.
